(19) United States
(12) Patent Application Publication
(10) Pub. No.: US 2002/0077107 A1
(43) Pub. Date: Jun. 20, 2002

(54) Method and system for automatic selection of wireless carriers

(75) Inventors: Chi K. Eng, Wayne, NJ (US); Alex Mashinsky, New York, NY (US)

Correspondence Address: COHEN, PONTANI, LIEBERMAN & PAVANE, Suite 1210, 551 Fifth Avenue, New York, NY, 10176, US

(73) Assignee: Arbinet-thexchange, Inc.

(21) Appl. No.: 09/977,465

(22) Filed: Oct. 15, 2001

Related U.S. Application Data
(60) Provisional application No. 60/240,141, filed on Oct. 13, 2000.

(51) Int. Cl. H04Q 7/20

(52) U.S. Cl. 455/445; 455/466; 455/406

(57) ABSTRACT

A method for automatic selection of a wireless carrier by transmitting subscription information from a wireless terminal to a telecommunication node. Data relating to the fees charged by each of a plurality of cellular networks is stored at the telecommunications node. When a telecommunication transmission request is received at the telecommunication node, the telecommunication node determines an optimal route based on the stored data and the subscription information.

### BACKGROUND OF THE INVENTION

1. Field of the Invention

The present invention relates to a method and system for automatic selection of a wireless carrier by a user of a wireless phone in an area not served by a home network of the wireless phone.

2. Description of the Related Art

Presently, a wireless phone user selects one of many wireless services providers and subscribes to a calling plan based on his or her anticipated usage. There is a need for a system that permits a wireless phone user to automatically and instantaneously select a wireless service provider immediately prior to the making of a call.

### SUMMARY OF THE INVENTION

An objective of the present invention is to lower the fees incurred by users of cellular networks while traveling in areas not served by their home networks.

Another objective of the present invention is to allow the users of cellular networks to continue to use their wireless terminals in a conventional manner, without requiring the users to download or install special software.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWING

FIG. 1 is a block diagram depicting a preferred embodiment of the present invention.

### DETAILED DESCRIPTION OF THE PRESENTLY PREFERRED EMBODIMENTS

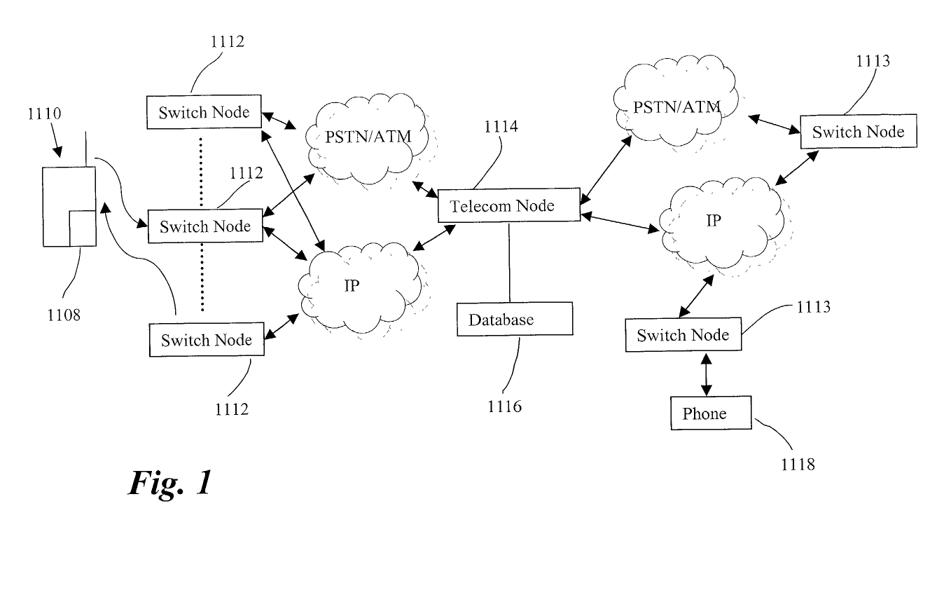

FIG. 1 diagrammatically illustrates a wireless-carrier selection system of the present invention. As shown, the system includes a first telecommunication node 1108 incorporated in a wireless terminal 1110 such as, for example, a cellular phone, a laptop computer, a personal digital assistant, etc. The wireless terminal 1110 is configured to communicate with a plurality of switch nodes 1112, each of which is capable of routing telecommunication transmission or traffic such as, voice, data and video transmission, between the wireless terminal 1110 and another wireless terminal, telephone equipment, Web server, or computer equipment, etc. Similarly, the system includes another set of switch nodes 1113, each of which is capable of communicating with a terminal such as, for example, a telephone (wireline or wireless), a laptop computer, a personal digital assistant, etc.

Each switch node 1112, 1113 may be configured as node of a public switched telecommunications network (PSTN) or as a node of a conventional wireless communications network such as, for example, a Global System for Mobile Communications (GSM) or Wireless Intelligent Network. In the case where the wireless communications network is constructed as a GSM, the network includes a Gateway, a Home Location Register (HLR), and a Mobile Switching Center (MSC). The wireless network may employ multiplexing schemes such as, for example, Code-Division Multiple Access (CDMA) or Time-Division Multiple Access (TDMA). In the case where the wireless network is constructed as a 3-G network, the network includes a radio access network portion and a core network portion.

Switch nodes 1112 may be connected to each other through a circuit-switched network (e.g., the PSTN) or a packet-switched network such as an Internet Protocol (IP) network and an Asynchronous Transfer Mode (ATM) network.

Advantageously, the system includes a second telecommunication node 1114 configured to automatically select a serving network from one of the switch nodes 1112 in a manner transparent to the user of the wireless terminal. Telecommunication node 1114 is accessible by telecommunication node 1108 of the wireless terminal 1110 through a wireless access network. Preferably, telecommunication node 1114 includes a database 1116 containing route information relating to costs and quality of service of different routes connecting, for example, the various switch nodes 1112. Using this information and a known routing algorithm, telecommunication node 1114 can determine an optimal route (e.g., a least-cost route) for transmitting communications between switch nodes 1112 and 1113. The database 1116 may further include authentication data for validating access by a user. Telecommunication node 1114 may be connected to the various switch nodes 1112 and 1113 through, for example, an IP network, ATM network, or a PSTN network. Telecommunication node 1114 is adapted to receive and send telecommunication transmission through switch nodes 1112, 1113 from terminal 1110.

Terminal 1110 may include a Subscriber Identification Module (SIM) for storing subscription information including the identity and capability of the wireless terminal (e.g., capable of communicating in TDMA, CDMA, W-CDMA, and/or CDMA-2000) and the user's profile. The user's profile may include authentication information (e.g., encrypted user password), network parameters (e.g., GSM), and quality of service parameters (e.g., Answer Seizure Ratio and Post Dial Delay). In a particularly preferred embodiment, the SIM also stores data relating to the user's privilege to access one or more of the switch nodes 1112 so that telecommunication node 1114 can eliminate from its list of possible routes those switch nodes the user does not have privilege to access.

In use, telecommunication node 1108 of the wireless terminal 1110 transmits (e.g., during power up) to telecommunication node 1114, through one of the switch nodes 1112, subscription information contained in the SIM for transmission setup. Alternatively, the subscription information may be transmitted through a public wireless access network that provides a public access channel. The subscription information may be transmitted in a form similar to, for example, a Short Messaging Service (SMS) or Wireless Application Protocol (WAP) message or any message format understood by telecommunication node 1114, without requiring additional actions or inputs from the user. After successful authentication, telecommunication node 1114 stores the subscription information and prepares to receive further messages or transmission requests from terminal 1110. Upon prompting by the user, telecommunication node 1108 transmits a transmission request including the telephone number of a called party to telecommunication node 1114; telecommunication node 1114 then determines an optimal route from the wireless terminal to the called party's telephone equipment 1118 using the subscription information and the route information stored in the database 1116. Preferably, telecommunication node 1114 receives service offers from the various switch node operators (e.g., cellular network operators) so that the computation of an optimal route includes selecting the switch node that offers the lowest service charge. The selection process may include matching switch nodes that satisfy the quality of service, network, and pricing parameters contained in the subscription information. In this manner, the user can minimize charges while traveling outside his home cellular network. After determining an optimal route from switch node 1112, telecommunication node 1114 then initiates a first telecommunication transmission to the wireless terminal 1110 and a second telecommunication transmission to the called party's telephone equipment 1118 through the selected switch node 1112 along the optimal route. Once the telecommunication transmission paths to the wireless terminal 1110 and telephone equipment 1118 are successfully established, telecommunication node 1114 bridges the paths between terminal 1110 and telephone equipment 1118.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of routing telecommunication traffic to and from a wireless terminal through one of a plurality of cellular networks accessible by the wireless terminal, comprising the steps of:
transmitting by the wireless terminal to a telecommunication node subscription information including a user's profile;
storing data relating to fees charged by each of the plurality of cellular networks;
receiving by the telecommunication node a telecommunication transmission request from the wireless terminal, the telecommunication transmission request comprising a called party's telephone number; and
determining by the telecommunication node an optimal route including the selection of one of the plurality of cellular networks for routing telecommunication traffic to and from the wireless terminal based on the subscription information from the wireless terminal.

2. The method of claim 1, further comprising the step of initiating a first telecommunication transmission to the wireless terminal and a second telecommunication transmission to the called party using the optimal route.

3. The method of claim 2, further comprising the step of bridging the first and second telecommunication transmissions.

4. The method of claim 1, wherein the user's profile includes the user's privilege to access one or more of the cellular networks.

5. The method of claim 1, wherein the user's profile is transmitted as a Short Messaging Service.
